(19) United States
(12) Patent Application Publication
(10) Pub. No.: US 2014/0120935 A1
(43) Pub. Date: May 1, 2014

(54) METHOD, BASE STATION, AND RADIO NETWORK CONTROLLER FOR PARAMETER CONFIGURATION DURING CHANNEL SWITCHING

(71) Applicant: HUAWEI TECHNOLOGIES CO., LTD., Shenzhen (CN)

(72) Inventors: Bingzhao Li, Beijing (CN); Yanyan Chen, Beijing (CN); Xiaoxiao Zheng, Shanghai (CN)

(73) Assignee: HUAWEI TECHNOLOGIES CO., LTD., Shenzhen (CN)

(21) Appl. No.: 14/147,910

(22) Filed: Jan. 6, 2014

Related U.S. Application Data
(63) Continuation of application No. PCT/CN2012/078269, filed on Jul. 6, 2012.

(30) Foreign Application Priority Data
Jul. 6, 2011 (CN) 201110188338.0

(51) Int. Cl. H04W 72/04

(52) U.S. Cl. CPC H04W 72/0446; H04W 72/0433
USPC 455/452.1; 455/560; 455/561

(57) ABSTRACT

A method for parameter configuration during channel switching is disclosed. After a common enhanced dedicated channel for uplink use to a terminal, a base station calculates an F-DPCH timing offset of the terminal in a non-Cell-DCH state, calculates a second F-DPCH timeslot format according to a first F-DPCH timing offset, a first F-DPCH timeslot format, and the F-DPCH timing offset of the terminal in the non-Cell-DCH state, and establishes a radio link by using the F-DPCH timing offset of the terminal in the non-Cell-DCH state and the second F-DPCH timeslot format. The method for parameter configuration during channel switching that is provided in an embodiment of the present invention can avoid interruption of uplink data transmission of the terminal. Embodiments of the present invention further provide a corresponding radio network controller and base station.

### CROSS-REFERENCE TO RELATED APPLICATIONS

This application is a continuation of International Application No. PCT/CN2012/078269, filed on Jul. 6, 2012, which claims priority to Chinese Patent Application No. 201110188338.0, filed on Jul. 6, 2011, both of which are hereby incorporated by reference in their entireties.

### TECHNICAL FIELD

Embodiments of the present invention relate to the field of communications technologies, and in particular, to a method, a base station, and a radio network controller for parameter configuration during channel switching.

### BACKGROUND

In a time division-synchronous code division multiple access (TD-SCDMA, Time Division-Synchronous Code Division Multiple Access) system, a terminal (UE, User Equipment) has four connection states, which are a cell dedicated channel (Cell-DCH) state, a cell forward access channel (Cell-FACH) state, a cell paging channel (Cell-PCH) state, and a terrestrial radio access network registration area paging channel (URA-PCH) state; and besides the connection states, the terminal also has an idle state. The idle state, the cell forward access channel (Cell-FACH) state, the cell paging channel (Cell-PCH) state, and the terrestrial radio access network registration area paging channel (URA-PCH) state are called non-Cell-DCH states.

When a data volume is small, the terminal is in a non-Cell-DCH state, and after the data volume increases, the terminal needs to be switched to the (Cell-DCH) state. A process of switching from a non-Cell-DCH state to the (Cell-DCH) state is described as follows: Because the data volume increases, the terminal reports the data volume to a radio network controller (RNC, Radio Network Controller) through a data measurement report; and after determining that a channel state of the terminal needs to be switched from the non-Cell-DCH state to the (Cell-DCH) state, the radio network controller requests a base station (NodeB) to establish a radio link for the terminal and carries a fractional dedicated physical control channel ((F-DPCH), Fractional Dedicated Physical Control Channel) configuration parameter in a request for notifying the base station of establishing the radio link, where the configuration parameter includes an F-DPCH timing offset and an F-DPCH timeslot format. One (F-DPCH) may be multiplexed by 10 terminals, and each timeslot of the (F-DPCH) is divided into 10 parts, and each part corresponds to one location. Each user is allocated to a fixed location, and in the (Cell-DCH) state, a location to which a user is specifically allocated is decided by the radio network controller and is informed, through an F-DPCH timing offset and an F-DPCH timeslot format, to the base station. A user location to be used by the terminal is finally decided through a combination of the F-DPCH timing offset and the F-DPCH timeslot format. After successfully establishing the radio link, the base station sends a radio link establishment success message to the radio network controller, and then, the radio network controller sends the F-DPCH configuration parameter to the terminal; and after a channel state change confirmation message is received from the terminal, the switching from the non-Cell-DCH state to the (Cell-DCH) state is complete.

Currently, in a process of switching from a non-Cell-DCH state to the (Cell-DCH) state, a timing relationship may be changed. The timing relationship represents a timing offset between each (Cell-DCH) of a terminal and a downlink common pilot channel of a cell, and in a high speed packet access (HSPA, High Speed Packet Access) system, an (F-DPCH) is a basis of the timing offset, and timing offsets of all other channels are based on the (F-DPCH). Therefore, the timing relationship depends on the F-DPCH timing offset. Currently in a switching process, the timing relationship may be changed because the F-DPCH timing offset of the terminal is calculated through the following formula in a non-Cell-DCH state:

τ_{(F-DPCH)}=[(5120*AICH access slot # with the AI)+10240+256*S_{offset}] mod 38400;

where

the AICH access slot # with the AI is a timeslot number of an AICH and is a time point of a Node B responding to uplink access when a Cell FACH user initiates the access, and a value is any number from 0 to 14; and the Soffset is a common enhanced dedicated channel resource number that is broadcast to the terminal in a network common enhanced dedicated channel (common EDCH, common Enhanced Dedicated Channel) resource, and a value is any number from 0 to 9.

In the foregoing technical solution, only the F-DPCH configuration parameter sent by the radio network controller can be used, and the radio link established by the base station for the terminal by using the F-DPCH configuration parameter sent by the radio network controller causes interruption of uplink data transmission of the terminal.

### SUMMARY

In multiple aspects, the present invention provides a method, a base station, and a radio network controller for parameter configuration during channel switching, so that a base station keeps an F-DPCH timing offset of a terminal in a non-Cell-DCH state unchanged when establishing a radio link for the terminal, thereby avoiding interruption of uplink data transmission of the terminal.

In one aspect, the present invention provides a method for parameter configuration during channel switching, which includes:

sending a radio link establishment request message to a base station, where the radio link establishment request message carries a fractional dedicated physical control channel F-DPCH configuration parameter, and the F-DPCH configuration parameter includes a first F-DPCH timing offset and a first F-DPCH timeslot format; and

receiving a radio link establishment completion response message, where the radio link establishment completion response message includes first instruction information, the first instruction information is used to instruct the base station to perform channel switching with a timing relationship kept, and the first instruction information carries an F-DPCH timing offset of a terminal in a non-cell dedicated channel (Cell-DCH) state, or a parameter for calculating an F-DPCH timing offset of a terminal in a non-Cell-DCH state, and/or a second F-DPCH timeslot format.

In another aspect, the present invention provides a method for parameter configuration during channel switching, which includes:

after a common enhanced dedicated channel for uplink use is allocated to a terminal, obtaining a parameter for calculating an F-DPCH timing offset of the terminal in a non-Cell-DCH state;

calculating the F-DPCH timing offset of the terminal in the non-Cell-DCH state by using the parameter for calculating the F-DPCH timing offset of the terminal in the non-Cell-DCH state;

receiving a radio link establishment request message sent by a radio network controller, where the radio link establishment request message carries an F-DPCH configuration parameter, and the F-DPCH configuration parameter includes a first F-DPCH timing offset and a first F-DPCH timeslot format;

calculating a second F-DPCH timeslot format according to the first F-DPCH timing offset, the first F-DPCH timeslot format, and the F-DPCH timing offset of the terminal in the non-Cell-DCH state;

establishing a radio link by using the F-DPCH timing offset of the terminal in the non-Cell-DCH state and the second F-DPCH timeslot format; and

sending a radio link establishment completion response message to the radio network controller, where the radio link establishment completion response message includes first instruction information, the first instruction information is used to instruct a base station to perform channel switching with a timing relationship kept, and the first instruction information carries a parameter for calculating the F-DPCH timing offset parameter of the terminal in the non-Cell-DCH state and/or the second F-DPCH timeslot format.

In one aspect, the present invention provides a method for parameter configuration during channel switching, which includes:

sending a radio link establishment request message to a base station, where the radio link establishment request message carries a fractional dedicated physical control channel F-DPCH configuration parameter, and the F-DPCH configuration parameter includes a first F-DPCH timing offset and a first F-DPCH timeslot format; and

receiving a radio link establishment completion response message, where the radio link establishment completion response message includes first instruction information, the first instruction information is used to instruct the base station to perform channel switching with a timing relationship kept, and the first instruction information carries an F-DPCH timing offset of a terminal in a non-Cell-DCH state and/or a parameter for calculating the F-DPCH timing offset of the terminal in the non-Cell-DCH state.

In another aspect, the present invention provides a method for parameter configuration during channel switching, which includes:

after a common enhanced dedicated channel for uplink use is allocated to a terminal, obtaining a parameter for calculating an F-DPCH timing offset of the terminal in a non-Cell-DCH state;

calculating the F-DPCH timing offset of the terminal in the non-Cell-DCH state by using the parameter for calculating the F-DPCH timing offset of the terminal in the non-Cell-DCH state;

receiving a radio link establishment request message sent by a radio network controller, where the radio link establishment request message carries an F-DPCH configuration parameter, and the F-DPCH configuration parameter includes a first F-DPCH timing offset and a first F-DPCH timeslot format;

when the F-DPCH timing offset of the terminal in the non-Cell-DCH state is an integer multiple of a timeslot, establishing a radio link by using the F-DPCH timing offset of the terminal in the non-Cell-DCH state and the first F-DPCH timeslot format; and

sending a radio link establishment completion response message to the radio network controller, where the radio link establishment completion response message includes first instruction information, the first instruction information is used to instruct a base station to perform channel switching with a timing relationship kept, and the first instruction information carries the F-DPCH timing offset of the terminal in the non-Cell-DCH state and/or the parameter for calculating the F-DPCH timing offset of the terminal in the non-Cell-DCH state.

In one aspect, the present invention provides a method for parameter configuration during channel switching, which includes:

receiving an F-DPCH timing offset of a terminal in a non-Cell-DCH state or a parameter for calculating an F-DPCH timing offset of a terminal in a non-Cell-DCH state that is sent by a base station;

sending a radio link establishment request message to the base station, where the radio link establishment request message carries a second F-DPCH timeslot format; and

receiving a radio link establishment completion response message, where the radio link establishment completion response message includes first instruction information, and the first instruction information is used to instruct the base station to perform channel switching with a timing relationship kept.

In another aspect, the present invention provides a method for parameter configuration during channel switching, which includes:

after a common enhanced dedicated channel for uplink use is allocated to a terminal, obtaining a parameter for calculating an F-DPCH timing offset of the terminal in a non-Cell-DCH state;

calculating the F-DPCH timing offset of the terminal in the non-Cell-DCH state by using the parameter for calculating the F-DPCH timing offset of the terminal in the non-Cell-DCH state;

sending the F-DPCH timing offset of the terminal in the non-Cell-DCH state or the parameter for calculating the F-DPCH timing offset of the terminal in the non-Cell-DCH state to a radio network controller;

receiving a second F-DPCH timeslot format sent by the radio network controller;

establishing a radio link by using the F-DPCH timing offset of the terminal in the non-Cell-DCH state and the second F-DPCH timeslot format; and

sending a radio link establishment completion response message, where the radio link establishment completion response message includes first instruction information, and the first instruction information is used to instruct a base station to perform channel switching with a timing relationship kept.

A radio network controller is provided, which includes:

a sending unit, configured to send a radio link establishment request message to a base station, where the radio link establishment request message carries a fractional dedicated physical control channel F-DPCH configuration parameter, and the F-DPCH configuration parameter includes a first F-DPCH timing offset and a first F-DPCH timeslot format; and

a receiving unit, configured to receive a radio link establishment completion response message, where the radio link establishment completion response message includes first instruction information, the first instruction information is used to instruct the base station to perform channel switching with a timing relationship kept, and the first instruction information carries an F-DPCH timing offset of a terminal in a non-Cell-DCH state, or a parameter for calculating an F-DPCH timing offset of a terminal in a non-Cell-DCH state, and/or a second F-DPCH timeslot format.

A base station is provided, which includes:

an obtaining unit, configured to, after a common enhanced dedicated channel for uplink use is allocated to a terminal, obtain a parameter for calculating an F-DPCH timing offset of the terminal in a non-Cell-DCH state;

a calculation unit, configured to calculate the F-DPCH timing offset of the terminal in the non-Cell-DCH state by using the parameter for calculating the F-DPCH timing offset of the terminal in the non-Cell-DCH state that is obtained by the obtaining unit;

a receiving unit, configured to receive a radio link establishment request message sent by a radio network controller, where the radio link establishment request message carries an F-DPCH configuration parameter, the F-DPCH configuration parameter includes a first F-DPCH timing offset and a first F-DPCH timeslot format, and

the calculation unit is further configured to calculate a second F-DPCH timeslot format according to the first F-DPCH timing offset, the first F-DPCH timeslot format, and the F-DPCH timing offset of the terminal in the non-Cell-DCH state;

a radio link establishment unit, configured to establish a radio link by using the F-DPCH timing offset of the terminal in the non-Cell-DCH state and the second F-DPCH timeslot format that are calculated by the calculation unit; and

a sending unit, configured to send a radio link establishment completion response message to the radio network controller after the radio link establishment unit establishes the radio link, where the radio link establishment completion response message includes first instruction information, the first instruction information is used to instruct the base station to perform channel switching with a timing relationship kept, and the first instruction information carries the F-DPCH timing offset of the terminal in the non-Cell-DCH state, or the parameter for calculating the F-DPCH timing offset of the terminal in the non-Cell-DCH state, and/or the second F-DPCH timeslot format.

A radio network controller is provided, which includes:

a sending unit, configured to send a radio link establishment request message to a base station, where the radio link establishment request message carries a fractional dedicated physical control channel F-DPCH configuration parameter, and the F-DPCH configuration parameter includes a first F-DPCH timing offset and a first F-DPCH timeslot format; and

a receiving unit, configured to receive a radio link establishment completion response message, where the radio link establishment completion response message includes first instruction information, the first instruction information is used to instruct the base station to perform channel switching with a timing relationship kept, and the first instruction information carries an F-DPCH timing offset of a terminal in a non-Cell-DCH state and/or a parameter for calculating the F-DPCH timing offset of the terminal in the non-Cell-DCH state.

A base station is provided, which includes:

an obtaining unit, configured to, after a common enhanced dedicated channel for uplink use is allocated to a terminal, obtain a parameter for calculating an F-DPCH timing offset of the terminal in a non-Cell-DCH state;

a calculation unit, configured to calculate the F-DPCH timing offset of the terminal in the non-Cell-DCH state by using the parameter for calculating the F-DPCH timing offset of the terminal in the non-Cell-DCH state;

a receiving unit, configured to receive a radio link establishment request message sent by a radio network controller, where the radio link establishment request message carries an F-DPCH configuration parameter, and the F-DPCH configuration parameter includes a first F-DPCH timing offset and a first F-DPCH timeslot format;

a radio link establishment unit, configured to, when the F-DPCH timing offset of the terminal in the non-Cell-DCH state is an integer multiple of a timeslot, establish a radio link by using the F-DPCH timing offset of the terminal in the non-Cell-DCH state that is calculated by the calculation unit and the first F-DPCH timeslot format received by the receiving unit; and

a sending unit, configured to send a radio link establishment completion response message to the radio network controller after the radio link establishment unit establishes the radio link, where the radio link establishment completion response message includes first instruction information, the first instruction information is used to instruct the base station to perform channel switching with a timing relationship kept, and the first instruction information carries the F-DPCH timing offset of the terminal in the non-Cell-DCH state and/or the parameter for calculating the F-DPCH timing offset of the terminal in the non-Cell-DCH state.

A radio network controller is provided, which includes:

a receiving unit, configured to receive an F-DPCH timing offset of a terminal in a non-Cell-DCH state or a parameter for calculating an F-DPCH timing offset of a terminal in a non-Cell-DCH state that is sent by a base station; and

a sending unit, configured to send a radio link establishment request message to the base station, where the radio link establishment request message carries a second F-DPCH timeslot format, and

the receiving unit is further configured to receive a radio link establishment completion response message, where the radio link establishment completion response message includes first instruction information, and the first instruction information is used to instruct the base station to perform channel switching with a timing relationship kept.

A base station is provided, which includes:

an obtaining unit, configured to, after a common enhanced dedicated channel for uplink use is allocated to a terminal, obtain a parameter for calculating an F-DPCH timing offset of the terminal in a non-Cell-DCH state;

a calculation unit, configured to calculate the F-DPCH timing offset of the terminal in the non-Cell-DCH state by using the parameter for calculating the F-DPCH timing offset of the terminal in the non-Cell-DCH state that is obtained by the obtaining unit;

a sending unit, configured to send the F-DPCH timing offset of the terminal in the non-Cell-DCH state that is calculated by the calculation unit or the parameter for calculating the F-DPCH timing offset of the terminal in the non-Cell-DCH state that is obtained by the obtaining unit to a radio network controller;

a receiving unit, configured to receive a radio link establishment request message sent by the radio network controller, where the radio link establishment request message carries a second F-DPCH timeslot format; and

a radio link establishment unit, configured to establish a radio link by using the F-DPCH timing offset of the terminal in the non-Cell-DCH state that is calculated by the calculation unit and the second F-DPCH timeslot format that is received by the receiving unit, where

the sending unit is further configured to send a radio link establishment completion response message after the radio link establishment unit establishes the radio link, where the radio link establishment completion response message includes first instruction information, and the first instruction information is used to instruct the base station to perform channel switching with a timing relationship kept.

In multiple embodiments of the present invention, when a base station establishes a radio link for a terminal, an F-DPCH timing offset of the terminal in a non-Cell-DCH state is kept unchanged, thereby avoiding interruption of uplink data transmission of the terminal.

### BRIEF DESCRIPTION OF DRAWINGS

FIG. 1 is a schematic diagram of an embodiment of a method for parameter configuration during channel switching according to an embodiment of the present invention;

FIG. 2 is a schematic diagram of an embodiment of a method for parameter configuration during channel switching according to an embodiment of the present invention;

FIG. 3 is a schematic diagram of another embodiment of a method for parameter configuration during channel switching according to an embodiment of the present invention;

FIG. 4 is a schematic diagram of another embodiment of a method for parameter configuration during channel switching according to an embodiment of the present invention;

FIG. 5 is a schematic diagram of another embodiment of a method for parameter configuration during channel switching according to an embodiment of the present invention;

FIG. 6 is a schematic diagram of another embodiment of a method for parameter configuration during channel switching according to an embodiment of the present invention;

FIG. 7 is a schematic diagram of an embodiment of a base station and a radio network controller according to an embodiment of the present invention;

FIG. 8 is a schematic diagram of another embodiment of a base station and a radio network controller according to an embodiment of the present invention; and

FIG. 9 is a schematic diagram of another embodiment of a base station and a radio network controller according to an embodiment of the present invention.

### DESCRIPTION OF EMBODIMENTS

An embodiment of the present invention provides a method for parameter configuration during channel switching. When establishing a radio link for a terminal, a base station can configure a parameter by itself according to according to whether the terminal uses a common enhanced dedicated channel at uplink for data transmission, thereby avoiding interruption of uplink data transmission of the terminal. Embodiments of the present invention further provide a corresponding base station and radio network controller. Details are described in the following.

The following descriptions are for illustration but are not for limitation. Specific details such as a structure of a specific system, an interface, a technology are provided for thoroughly understanding the present invention. However, persons skilled in the art should be clear that, the present invention can also be implemented in other embodiments without these specific details. In other cases, detailed illustrations about a well-known apparatus, circuit, and method are omitted, so as to avoid that unnecessary details interfere with describing the present invention.

Various technologies described in this document can be used in various radio communication systems, for example, current 2G and 3G communication systems and a next-generation communication system, for example, a global system for mobile communications (GSM, Global System for Mobile Communications), a code division multiple access (CDMA, Code Division Multiple Access) system, a time division multiple access (TDMA, Time Division Multiple Access) system, wideband code division multiple access (WCDMA, Wideband Code Division Multiple Access) system, a frequency division multiple access (FDMA, Frequency Division MultipleAccess) system, an orthogonal frequency division multiple access (OFDMA, Orthogonal Frequency-Division Multiple Access) system, a single carrier FDMA (SC-FDMA) system, a general packet radio service (GPRS, General Packet Radio Service) system, a long term evolution (LTE, Long Term Evolution) system, and another communication system of this type.

Various aspects are described in this document with reference to a terminal and/or a base station and/or a controller.

A terminal may be a wireless terminal or a wired terminal. The wireless terminal may refer to a device providing voice and/or data connectivity for a user, a handheld device with a wireless connection function, or another processing device connected to a wireless modem. The wireless terminal may communicate with one or more core networks through a radio access network (for example, RAN, Radio Access Network). The wireless terminal may be a mobile terminal such as a mobile phone (or called a “cellular” phone) and a computer having a mobile terminal, for example, may be a portable, pocket-sized, handheld, computer built-in, or vehicle-mounted mobile apparatus, which exchange language and/or data with the radio access network, for example, a device such as a personal communication service (PCS, Personal Communication Service) phone, a cordless telephone, a session initiation protocol (SIP) telephone set, a wireless local loop (WLL, Wireless Local Loop) station, and a personal digital assistant (PDA, Personal Digital Assistant). The wireless terminal may also be called a system, a subscriber unit (Subscriber Unit), a subscriber station (Subscriber Station), a mobile station (Mobile Station), a mobile station (Mobile), a remote station (Remote Station), an access point (Access Point), a remote terminal (Remote Terminal), an access terminal (Access Terminal), a user terminal (User Terminal), a user agent (User Agent), a user device (User Device), or a user equipment (User Equipment).

A base station (for example, an access point) may refer to a device that communicates with a wireless terminal through one or more sectors on an air interface in an access network. The base station may be used to perform mutual conversion on a received air frame and an IP packet, and be used as a router between the wireless terminal and another part of the access network, where the another part of the access network may include an Internet Protocol (IP) network. The base station may further coordinate attribute management on the air interface. For example, the base station may be a base station (BTS, Base Transceiver Station) in the GSM or CDMA, a base station (NodeB) in the WCDMA, or an evolved base station (NodeB or eNB or e-NodeB, evolved Node B) in the LTE, which is not limited in the present invention.

A base station controller may be a base station controller (BSC, base station controller) in the GSM or CDMA or a radio network controller (RNC, Radio Network Controller) in the WCDMA, which is not limited in the present invention.

In addition, in this document, terms “system” and “network” are usually interchangeably used in this document. In this document, a term “and/or” is only an association relationship for describing associated objects, and represents that three relationships may exist, for example, A and/or B may represent the following three cases: A exists separately, A and B exist at the same time, and B exists separately. In addition, a character “/” in this document generally represents that associated objects before and after the character are in an “or” relationship.

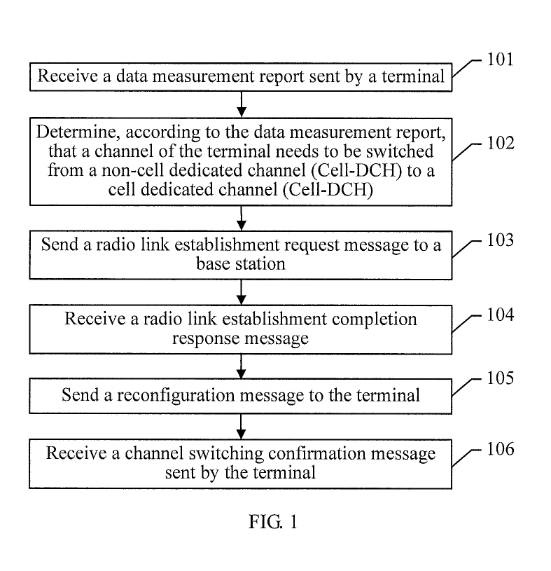

Referring to FIG. 1, an embodiment of a method for parameter configuration during channel switching according to an embodiment of the present invention includes the following steps:

101: Receive a data measurement report sent by a terminal.

When in a non-Cell-DCH state, the terminal proactively sends a data measurement report to a radio network controller because a data volume increases, where the data measurement report includes a size of the data volume when the terminal is in the non-Cell-DCH state.

102: Determine, according to the data measurement report, that a channel of the terminal needs to be switched from a non-Cell-DCH to a cell dedicated channel (Cell-DCH).

After receiving the data measurement report, the radio network controller determines, according to the size of the data volume in the data measurement report, whether the channel of the terminal needs to be switched from the non-Cell-DCH to the (Cell-DCH). If the data measurement report indicates that the data volume is greater than or equal to a threshold, the radio network controller determines that the channel of the terminal needs to be switched from the non-Cell-DCH to the (Cell-DCH), and 103 is performed. If the data measurement report indicates that the data volume is less than the threshold, the radio network controller determines that the channel of the terminal does not need to be switched from the non-Cell-DCH to the (Cell-DCH).

103: Send a radio link establishment request message to a base station.

When determining that the channel of the terminal needs to be switched from the non-Cell-DCH to the (Cell-DCH), the radio network controller sends the radio link establishment request message to the base station to request the base station to establish a radio link for the terminal.

The radio link establishment request message carries a fractional dedicated physical control channel F-DPCH configuration parameter, where the configuration parameter includes a first F-DPCH timing offset and a first F-DPCH timeslot format.

104: Receive a radio link establishment completion response message.

After the base station performs channel switching with a timing relationship kept, the base station sends the radio link establishment completion response message to the radio network controller. The radio network controller receives the radio link establishment completion response message, where the radio link establishment completion response message includes first instruction information, the first instruction information is used to instruct the base station to perform the channel switching with the timing relationship kept, that is, during the channel switching, the base station keeps an F-DPCH timing offset of the terminal in the non-Cell-DCH state unchanged, and the first instruction information carries the F-DPCH timing offset of the terminal in the non-Cell-DCH state, or a parameter for calculating the F-DPCH timing offset of the terminal in the non-Cell-DCH state, and/or a second F-DPCH timeslot format, where the parameter for calculating the F-DPCH timing offset of the terminal in the non-Cell-DCH state includes a timeslot number of an AICH and a soffset value.

The second F-DPCH timeslot format is calculated through the first F-DPCH timing offset, the first F-DPCH timeslot format, and the F-DPCH timing offset of the terminal in the non-Cell-DCH state under the premise of guaranteeing that a user location of the terminal in an (F-DPCH) in a radio link allocated by the radio network controller is unchanged, and that no matter whether the base station uses the first F-DPCH timing offset and the first F-DPCH timeslot format as configuration parameters or uses the F-DPCH timing offset of the terminal in the non-Cell-DCH state and the second F-DPCH timeslot format as the configuration parameters when establishing the radio link, a user location of the terminal in the (F-DPCH) is unchanged. A specific calculation process may be understood with reference to the following example.

A unit of the F-DPCH timeslot format is a symbol, and a unit of the F-DPCH timing offset is a chip.

First, a modulus operation is performed on 2560 (one timeslot has 2560 chips) by using the F-DPCH timing offset, and then, a remainder is divided by 256 to obtain a number from 0 to 9. It is assumed that the number is p1 and the F-DPCH timeslot format is p2, and then the user location is (p1+p2) mod 10.

For example, the F-DPCH timing offset is 4608, and the F-DPCH timeslot format is 5, and then the user location is calculated as follows:

4608 mod 2560=2048

2048/256=8

8+5=13

13 mod 10=3

Therefore, the user location of the terminal in the (F-DPCH) is 3.

It can be known from the foregoing example that, the user location of the terminal in the (F-DPCH) can be first calculated through the first F-DPCH timing offset and the first F-DPCH timeslot format, and then, the second F-DPCH timeslot format is calculated through the user location of the terminal in the (F-DPCH) and the F-DPCH timing offset of the terminal in the non-Cell-DCH state. The calculation processing is described as follows:

First, a modulus operation is performed on 2560 (one timeslot has 2560 chips) by using the F-DPCH timing offset of the terminal in the non-Cell-DCH state, and then, a remainder is divided by 256 chips to obtain a number from 0 to 9. It is assumed that the number is p4 and it is assumed that the user location is p3, and then the timeslot format is (10+p3−p4) mod 10.

If the radio link establishment completion response message does not include the first instruction information for performing the channel switching with the timing relationship kept, it indicates that when establishing the radio link, the base station uses the first F-DPCH timing offset and the first F-DPCH timeslot format that are sent by the radio network controller, instead of keeping the timing relationship.

105: Send a reconfiguration message to the terminal.

After receiving the radio link establishment completion response message, the radio network controller sends the reconfiguration message to the terminal, where the reconfiguration message carries the second F-DPCH timeslot format.

If the radio link establishment completion response message returned by the base station carries the second F-DPCH timeslot format, the radio network controller directly sends the reconfiguration message to the terminal.

If the radio link establishment completion response message returned by the base station only carries the F-DPCH timing offset of the terminal in the non-Cell-DCH state, the radio network controller needs to calculate a second F-DPCH timing offset by itself, and a calculation method is the same as a method for calculating the F-DPCH timing offset by the base station.

If the radio link establishment completion response message returned by the base station only carries the parameter for calculating the F-DPCH timing offset of the terminal in the non-Cell-DCH state, the radio network controller still needs to first calculate the F-DPCH timing offset of the terminal in the non-Cell-DCH state by using the parameter for calculating the F-DPCH timing offset parameter of the terminal in the non-Cell-DCH state, and a calculation method is the same as a calculation method of the terminal.

When the radio network controller receives the radio link establishment completion response message, the base station establishes the radio link for the terminal, the radio network controller notifies the terminal of the F-DPCH configuration parameter used when the base station establishes the radio link, so as to ensure that a channel switching parameter of the terminal is the same as a channel switching parameter of the base station, and guarantee normal communication between the terminal and the base station.

If the base station does not perform the channel switching with the timing relationship kept, the reconfiguration message sent by the radio network controller to the terminal carries the first F-DPCH timing offset and the first F-DPCH timeslot format.

106: Receive a channel switching confirmation message sent by the terminal.

After receiving the reconfiguration message sent by the radio network controller, the terminal learns, according to the second F-DPCH timeslot format carried in the reconfiguration message, that the base station performs the channel switching with the timing relationship kept, and the terminal also keeps the F-DPCH timing offset of the terminal in the non-Cell-DCH state unchanged, accesses, with reference to the second F-DPCH timeslot format, the radio link established by the base station, confirms that the channel of the terminal has been switched from the non-Cell-DCH to the (Cell-DCH), and sends the channel switching confirmation message to the radio network controller. After the radio network controller receives the channel switching confirmation message sent by the terminal, channel switching from the non-Cell-DCH to the (Cell-DCH) is completed.

If the reconfiguration message carries the first F-DPCH timing offset and the first F-DPCH timeslot format, the channel switching is completed according to an F-DPCH configuration parameter formulated by the radio network controller.

Optionally, in the foregoing embodiment, the radio link establishment request message further carries identification information, where the identification information is used to identify whether the radio network controller allows the base station to perform the channel switching with the timing relationship kept, and the identification information identifies, by using 0 and 1, whether the radio network controller allows the base station to perform the channel switching with the timing relationship kept; if the identification information indicates 0, the base station is not allowed, or if the identification information indicates 1, the base station is allowed.

The base station can perform switching with the timing relationship kept only when the identification information identifies that the switching with the timing relationship kept is allowed to be performed.

If the identification information identifies that the radio network controller does not allow the base station to perform the switching with the timing relationship kept, the base station can establish the radio link only by using the first F-DPCH timing offset and the first F-DPCH timeslot format.

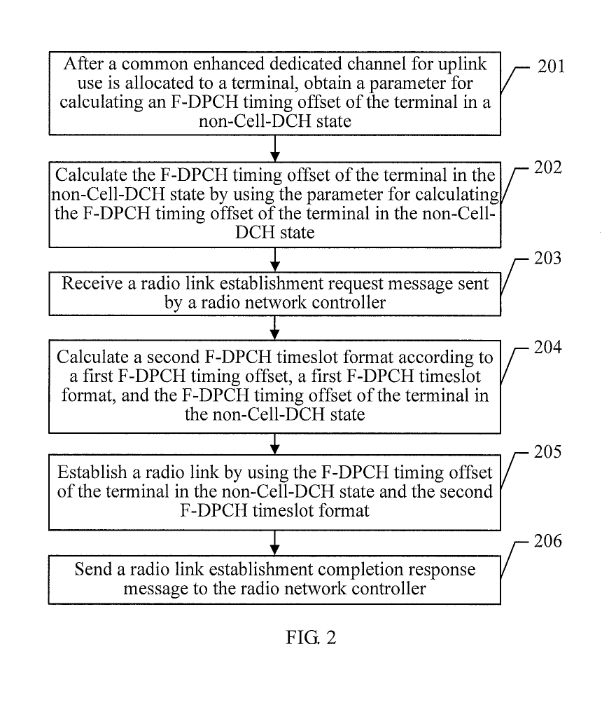

Referring to FIG. 2, an embodiment of a method for parameter configuration during channel switching includes the following steps:

201: After a common enhanced dedicated channel for uplink use is allocated to a terminal, obtain a parameter for calculating an F-DPCH timing offset of the terminal in a non-Cell-DCH state.

After the common enhanced dedicated channel for uplink use is allocated to the terminal, an F-DPCH timing offset of a base station in a non-Cell-DCH state has a value, and is the same as the F-DPCH timing offset of the terminal in the non-Cell-DCH state. If the terminal does not use the common enhanced dedicated channel at uplink, the F-DPCH timing offset of the base station in the non-Cell-DCH state is zero.

After the common enhanced dedicated channel for uplink use is allocated to the terminal, parameters, namely a timeslot number of an AICH and a soffset value, for calculating the F-DPCH timing offset of the terminal in the non-Cell-DCH state are obtained, and the F-DPCH timing offset of the terminal in the non-Cell-DCH state is calculated according to a formula for calculating the F-DPCH timing offset by the terminal.

202: Calculate the F-DPCH timing offset of the terminal in the non-Cell-DCH state by using the parameter for calculating the F-DPCH timing offset of the terminal in the non-Cell-DCH state.

203: Receive a radio link establishment request message sent by a radio network controller.

The base station receives the radio link establishment request message sent by the radio network controller, where the radio link establishment request message carries an F-DPCH configuration parameter, and the configuration parameter includes a first F-DPCH timing offset and a first F-DPCH timeslot format.

A user location of the terminal in an (F-DPCH) is decided by a combination of the first F-DPCH timing offset and the first F-DPCH timeslot format.

204: Calculate a second F-DPCH timeslot format according to the first F-DPCH timing offset, the first F-DPCH timeslot format, and the F-DPCH timing offset of the terminal in the non-Cell-DCH state.

A method for calculating the second F-DPCH timeslot format is the same as the calculation method mentioned in step 104, which is not further described herein.

205: Establish a radio link by using the F-DPCH timing offset of the terminal in the non-Cell-DCH state and the second F-DPCH timeslot format.

The base station uses the F-DPCH timing offset of the terminal in the non-Cell-DCH state and the second F-DPCH timeslot format as F-DPCH configuration parameters when establishing the radio link for the terminal.

206: Send a radio link establishment completion response message to the radio network controller, where the radio link establishment completion response message includes first instruction information, the first instruction information is used to instruct a base station to perform channel switching with a timing relationship kept, and the first instruction information carries an F-DPCH timing offset parameter of the terminal in the non-Cell-DCH state and/or the second F-DPCH timeslot format.

If the response message does not include the first instruction information for performing switching with the timing relationship kept, it indicates that when performing the channel switching, the base station uses the first F-DPCH timing offset and the first F-DPCH timeslot format that are sent by the radio network controller, instead of keeping the timing relationship.

In this embodiment, when the base station establishes the radio link for the terminal, if the terminal is using the common enhanced dedicated channel at uplink, the base station can establish the radio link for the terminal by using the F-DPCH timing offset of the terminal in the non-Cell-DCH state; compared with that a base station must establish a radio link according to an F-DPCH timing offset of the base station that is sent by a radio network controller in the prior art, the method for parameter configuration during channel switching that is provided in this embodiment of the present invention can avoid interruption of uplink data transmission of the terminal.

Optionally, in the foregoing embodiment, after the base station receives the radio link establishment request message, when the radio link establishment request message further carries identification information, the following is further included after 201:

The base station determines, through the identification information, whether the radio network controller allows the base station to perform the channel switching with the timing relationship kept, and the identification information identifies, by using 0 and 1, whether the radio network controller allows the base station to perform the channel switching with the timing relationship kept; if the identification information indicates 0, the base station is not allowed, or if the identification information indicates 1, the base station is allowed.

If the radio network controller allows the base station to perform the channel switching with the timing relationship kept, 202 is performed, or if the base station is not allowed, the base station performs the channel switching by using the first F-DPCH timing offset and the first F-DPCH timeslot format.

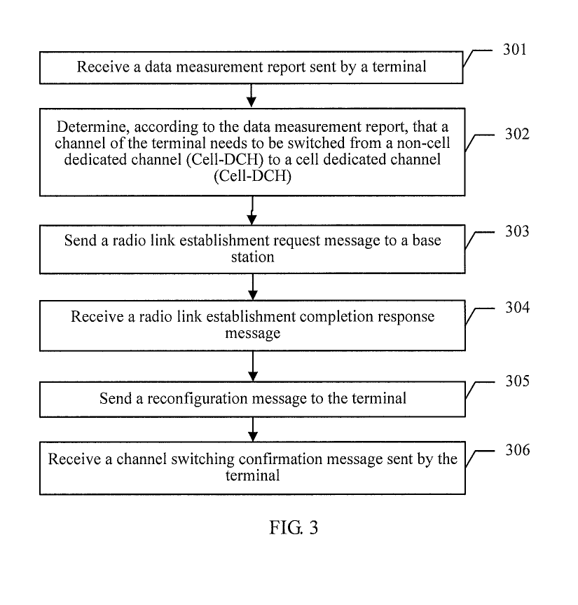

Referring to FIG. 3, another embodiment of a method for parameter configuration during channel switching according to an embodiment of the present invention includes the following steps:

301: Receive a data measurement report sent by a terminal.

302: Determine, according to the data measurement report, that a channel of the terminal needs to be switched from a non-Cell-DCH to a cell dedicated channel (Cell-DCH).

303: Send a radio link establishment request message to a base station.

The radio link establishment request message carries a fractional dedicated physical control channel F-DPCH configuration parameter, where the F-DPCH configuration parameter includes a first F-DPCH timing offset and a first F-DPCH timeslot format, and the first F-DPCH timing offset is an integer multiple of a timeslot.

This embodiment focuses on describing a situation where the F-DPCH timing offset is an integer multiple of a timeslot; therefore, when a radio network controller configures an (F-DPCH) parameter for the base station, the configured first F-DPCH timing offset is an integer multiple of a timeslot.

304: Receive a radio link establishment completion response message.

The radio network controller receives the radio link establishment completion response message, where the radio link establishment completion response message includes first instruction information, the first instruction information is used to instruct the base station to perform channel switching with a timing relationship kept, and the first instruction information carries an F-DPCH timing offset of the terminal in a non-Cell-DCH state and/or a parameter for calculating the F-DPCH timing offset of the terminal in the non-Cell-DCH state.

The radio network controller can know a multiple relationship between the F-DPCH timing offset of the terminal in the non-Cell-DCH state and a timeslot through calculation, and when the F-DPCH timing offset of the terminal in the non-Cell-DCH state is an integer multiple of a timeslot, the radio network controller can deduce that the base station uses the first F-DPCH timeslot format as a configuration parameter when establishing the radio link, or when the F-DPCH timing offset of the terminal in the non-Cell-DCH state is not an integer multiple of a timeslot, the radio network controller can also obtain a second F-DPCH timeslot format through calculation.

305: Send a reconfiguration message to the terminal.

The reconfiguration message carries the first F-DPCH timeslot format when the F-DPCH timing offset of the terminal in the non-Cell-DCH state is an integer multiple of a timeslot.

The reconfiguration message carries the second F-DPCH timeslot format when the F-DPCH timing offset of the terminal in the non-Cell-DCH state is not an integer multiple of a times lot.

306: Receive a channel switching confirmation message sent by the terminal.

In this embodiment, steps 301, 302, and 306 are the same as those in the embodiment shown in FIG. 1, and only steps 303, 304, and 305 are different from those in the embodiment shown in FIG. 1. The differences lie in that, in step 303, the first F-DPCH timing offset carried in the radio link establishment request message is an integer multiple of a timeslot, and in step 304, the radio network controller needs to first calculate whether the F-DPCH timing offset of the terminal in the non-Cell-DCH state is an integer multiple of a timeslot according to the F-DPCH timing offset of the terminal in the non-Cell-DCH state, and when sending the reconfiguration message, carries a different F-DPCH timeslot format for the F-DPCH timing offset being or not being an integer multiple of a timeslot.

Definitely, this embodiment aims at the situation where the F-DPCH timing offset of the terminal in the non-Cell-DCH state is an integer multiple of a timeslot. In fact, if the F-DPCH timing offset of the terminal in the non-Cell-DCH state is not an integer multiple of a timeslot, the radio network controller can also make a corresponding adjustment.

Optionally, in the foregoing embodiment, the radio link establishment request message further carries identification information, where the identification information is used to identify whether the radio network controller allows the base station to perform the channel switching with the timing relationship kept, and the identification information identifies, by using 0 and 1, whether the radio network controller allows the base station to perform the channel switching with the timing relationship kept; if the identification information indicates 0, the base station is not allowed, or if the identification information indicates 1, the base station is allowed.

The base station can perform switching with the timing relationship kept only when the identification information identifies that the switching with the timing relationship kept is allowed to be performed.

If the identification information identifies that the radio network controller does not allow the base station to perform the switching with the timing relationship kept, the base station can establish the radio link only by using the first F-DPCH timing offset and the first F-DPCH timeslot format.

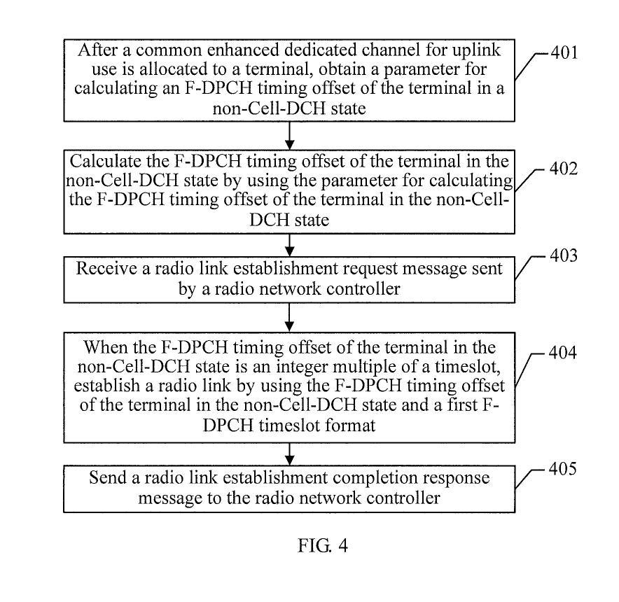

Referring to FIG. 4, another embodiment of the present invention that is shown in FIG. 4 includes the following steps:

401: After a common enhanced dedicated channel for uplink use is allocated to a terminal, obtain a parameter for calculating an F-DPCH timing offset of the terminal in a non-Cell-DCH state.

402: Calculate the F-DPCH timing offset of the terminal in the non-Cell-DCH state by using the parameter for calculating the F-DPCH timing offset of the terminal in the non-Cell-DCH state.

403: Receive a radio link establishment request message sent by a radio network controller.

404: When the F-DPCH timing offset of the terminal in the non-Cell-DCH state is an integer multiple of a timeslot, establish a radio link by using the F-DPCH timing offset of the terminal in the non-Cell-DCH state and a first F-DPCH timeslot format.

405: Send a radio link establishment completion response message to the radio network controller.

The radio link establishment completion response message includes first instruction information, where the first instruction information is used to instruct a base station to perform channel switching with a timing relationship kept, and the first instruction information carries the F-DPCH timing offset of the terminal in the non-Cell-DCH state and/or the parameter for calculating the F-DPCH timing offset of the terminal in the non-Cell-DCH state.

In this embodiment, 401 and 402 are the same as steps 201 and 202 in the embodiment shown in FIG. 2, which are not described in detail herein again; and differences are described as follows:

In step 403, a first F-DPCH timing offset carried in the radio link request message is an integer multiple of a timeslot, and in this embodiment, a step of calculating a second F-DPCH timeslot format is also omitted.

In step 404, it is directly set that the F-DPCH timing offset of the terminal in the non-Cell-DCH state is an integer multiple of a timeslot. Because when the F-DPCH timing offset of the terminal in the non-Cell-DCH state is an integer multiple of a timeslot, a user location is directly decided by the F-DPCH timeslot format, the base station can establish the radio link by directly using the F-DPCH timing offset of the terminal in the non-Cell-DCH state and the first F-DPCH timeslot format.

Because the base station establishes the radio link by using the first F-DPCH timeslot format as an F-DPCH configuration parameter, in step 405, the radio link establishment completion response message is sent, where the radio link establishment completion response message only needs to carry the F-DPCH timing offset of the terminal in the non-Cell-DCH state and/or the parameter for calculating the F-DPCH timing offset of the terminal in the non-Cell-DCH state. The radio network controller has stored the first F-DPCH timeslot format; therefore, the base station does not need to return the first F-DPCH timeslot format.

In this embodiment, when the base station establishes the radio link for the terminal, if the terminal is using the common enhanced dedicated channel at uplink, the base station can establish the radio link for the terminal by using the F-DPCH timing offset of the terminal in the non-Cell-DCH state, and when the F-DPCH timing offset of the terminal in the non-Cell-DCH state is an integer multiple of a timeslot, establishes the radio link by directly using the first F-DPCH timeslot format as an F-DPCH configuration parameter. Compared with that a base station must establish a radio link according to an F-DPCH timing offset of the base station that is sent by a radio network controller in the prior art, the method for parameter configuration during channel switching that is provided in this embodiment of the present invention can avoid interruption of uplink data transmission of the terminal.

Optionally, in the foregoing embodiment, after the base station receives the radio link establishment request message, when the radio link establishment request message further carries identification information, the following is further included after 401:

The base station determines, through the identification information, whether the radio network controller allows the base station to perform the channel switching with the timing relationship kept, and the identification information identifies, by using 0 and 1, whether the radio network controller allows the base station to perform the channel switching with the timing relationship kept; if the identification information indicates 0, the base station is not allowed, or if the identification information indicates 1, the base station is allowed.

If the radio network controller allows the base station to perform the channel switching with the timing relationship kept, 402 is performed, or if the base station is not allowed, the base station performs the channel switching by using the first F-DPCH timing offset and the first F-DPCH timeslot format.

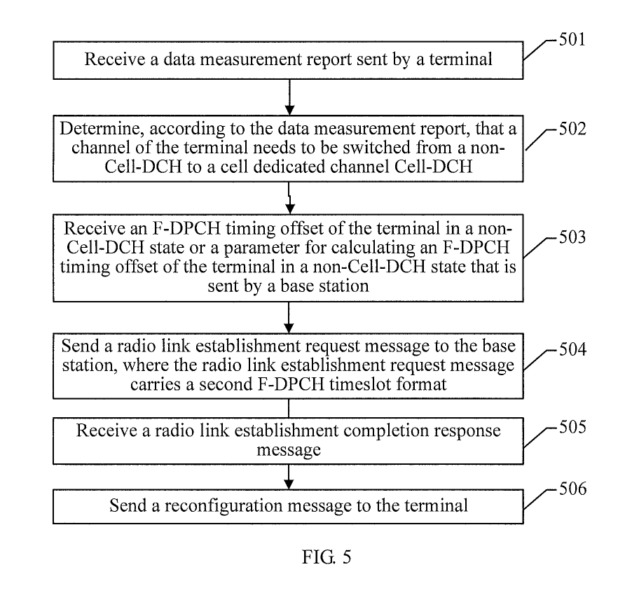

Referring to FIG. 5, an embodiment of the present invention that is shown in FIG. 5 includes the following steps:

501: Receive a data measurement report sent by a terminal.

502: Determine, according to the data measurement report, that a channel of the terminal needs to be switched from a non-Cell-DCH to a cell dedicated channel (Cell-DCH).

503: Receive an F-DPCH timing offset of the terminal in a non-Cell-DCH state or a parameter for calculating an F-DPCH timing offset of the terminal in a non-Cell-DCH state that is sent by a base station.

A radio network controller receives an F-DPCH timing offset of the base station in a non-Cell-DCH state or a parameter for calculating an F-DPCH timing offset of the base station in a non-Cell-DCH state that is sent by the base station, and the radio network controller calculates and obtains a second F-DPCH timeslot format according to a first F-DPCH timing offset, a first F-DPCH timeslot format, and an F-DPCH timing offset parameter of the terminal in the non-Cell-DCH state.

For example, a formula for calculating the F-DPCH timing offset of the terminal in the non-Cell-DCH state is as follows:

τ_{(F-DPCH)}=[(5120*AICH access slot # with the AI)+10240+256*Soffset] mod 38400; where

the AICH access slot # with the AI is a timeslot number of an AICH and is a time point of a Node B responding to uplink access when a Cell FACH user initiates the access, and a value is any number from 0 to 14; and the Soffset is a common enhanced dedicated channel resource number that is broadcast to the terminal in a network common enhanced dedicated channel (common EDCH, common Enhanced Dedicated Channel) resource, and a value is any number from 0 to 9.

For example, the parameter for calculating the F-DPCH timing offset of the terminal in the non-Cell-DCH state includes the AICH access slot # with the AI and the Soffset.

504: Send a radio link establishment request message to the base station, where the radio link establishment request message carries a second F-DPCH timeslot format.

The radio link establishment request message may further carry the first F-DPCH timing offset and the first F-DPCH timeslot format, where the first F-DPCH timing offset and the first F-DPCH timeslot format are used as configuration parameters for establishing a radio link in a situation where channel switching is performed without timing keeping.

When the F-DPCH timing offset of the terminal in the non-Cell-DCH state is an integer multiple of a timeslot, the first F-DPCH timeslot format and the second F-DPCH timeslot format are equal and carried in a same information element.

505: Receive a radio link establishment completion response message.

The radio link establishment completion response message includes first instruction information, where the first instruction information is used to instruct the base station to perform channel switching with a timing relationship kept, and the first instruction information does not need to carry any parameter.

506: Send a reconfiguration message to the terminal.

The radio network controller may configure, according to the first instruction information for keeping the timing relationship that is returned by the base station and then according to whether the F-DPCH timing offset of the terminal in the non-Cell-DCH state is an integer multiple of a timeslot, a parameter carried in the reconfiguration message.

Optionally, in the foregoing embodiment, the radio link establishment request message further carries identification information, where the identification information is used to identify whether the radio network controller allows the base station to perform the channel switching with the timing relationship kept, and the identification information identifies, by using 0 and 1, whether the radio network controller allows the base station to perform the channel switching with the timing relationship kept; if the identification information indicates 0, the base station is not allowed, or if the identification information indicates 1, the base station is allowed.

The base station can perform switching with the timing relationship kept only when the identification information identifies that the switching with the timing relationship kept is allowed to be performed.

If the identification information identifies that the radio network controller does not allow the base station to perform the switching with the timing relationship kept, the base station can establish the radio link only by using the first F-DPCH timing offset and the first F-DPCH timeslot format.

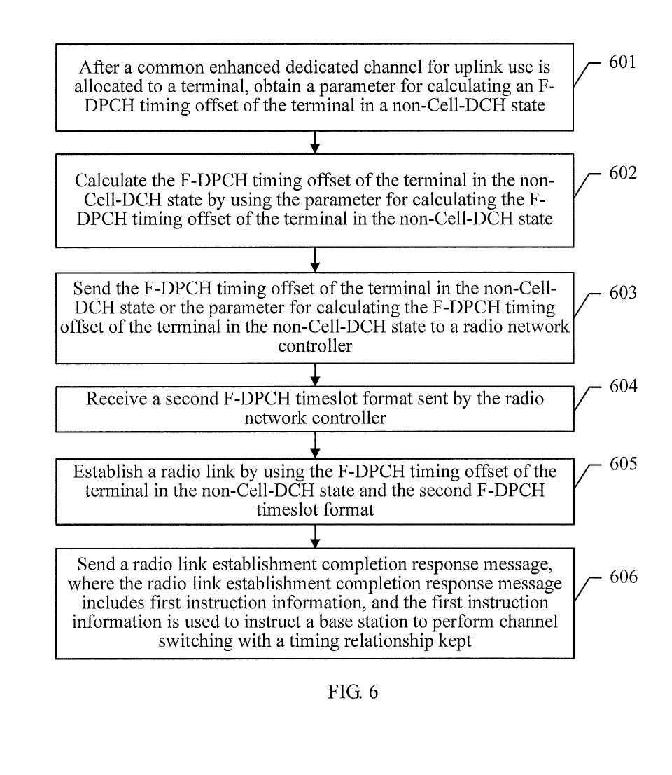

Referring to FIG. 6, an embodiment of the present invention that is shown in FIG. 6 includes the following steps:

601: After a common enhanced dedicated channel for uplink use is allocated to a terminal, obtain a parameter for calculating an F-DPCH timing offset of the terminal in a non-Cell-DCH state.

602: Calculate the F-DPCH timing offset of the terminal in the non-Cell-DCH state by using the parameter for calculating the F-DPCH timing offset of the terminal in the non-Cell-DCH state.

603: Send the F-DPCH timing offset of the terminal in the non-Cell-DCH state or the parameter for calculating the F-DPCH timing offset of the terminal in the non-Cell-DCH state to a radio network controller.

604: Receive a second F-DPCH timeslot format sent by the radio network controller.

605: Establish a radio link by using the F-DPCH timing offset of the terminal in the non-Cell-DCH state and the second F-DPCH timeslot format.

606: Send a radio link establishment completion response message, where the radio link establishment completion response message includes first instruction information, and the first instruction information is used to instruct a base station to perform channel switching with a timing relationship kept.

In this embodiment, the base station first sends the F-DPCH timing offset of the terminal in the non-Cell-DCH state to the radio network controller, the radio network controller configures two sets of F-DPCH) parameters for the base station according to an actual requirement, and when establishing the radio link for the terminal, the base station can establish the radio link for the terminal by using the F-DPCH timing offset of the terminal in the non-Cell-DCH state. Compared with that a base station must establish a radio link according to an F-DPCH timing offset of the base station that is sent by a radio network controller in the prior art, the method for parameter configuration during channel switching that is provided in this embodiment of the present invention can avoid interruption of uplink data transmission of the terminal.

Optionally, in the foregoing embodiment, after the base station receives the radio link establishment request message, when the radio link establishment request message further carries identification information, the following is further included after 401:

The base station determines, through the identification information, whether the radio network controller allows the base station to perform the channel switching with the timing relationship kept, and the identification information identifies, by using 0 and 1, whether the radio network controller allows the base station to perform the channel switching with the timing relationship kept; if the identification information indicates 0, the base station is not allowed, or if the identification information indicates 1, the base station is allowed.

If the radio network controller allows the base station to perform the channel switching with the timing relationship kept, 602 is performed, or if the base station is not allowed, the base station performs the channel switching by using a first F-DPCH timing offset and a first F-DPCH timeslot format.

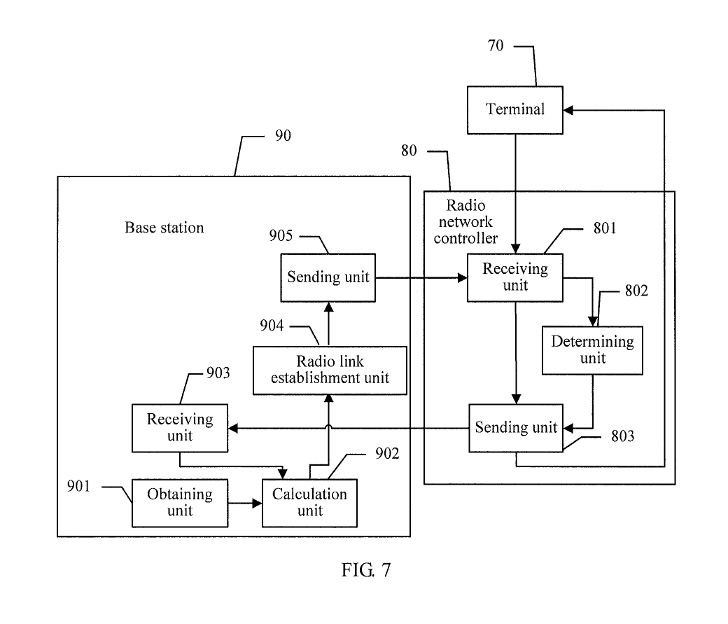

Embodiments of a base station and a radio network controller in the present invention are described in the following. Referring to FIG. 7, a radio network controller 80 in an embodiment of the present invention includes: a receiving unit 801, a determining unit 802, and a sending unit 803.

The receiving unit 801 is configured to, before the sending unit sends a radio link establishment request message to a base station, receive a data measurement report sent by a terminal, where the data measurement report is used to indicate a size of a data volume of the terminal.

The determining unit 802 is configured to determine, according to the data measurement report, that a channel of the terminal needs to be switched from a non-Cell-DCH to a cell dedicated channel (Cell-DCH).

The sending unit 803 is configured to send the radio link establishment request message to the base station, where the radio link establishment request message carries a fractional dedicated physical control channel F-DPCH configuration parameter, and the configuration parameter includes a first F-DPCH timing offset and a first F-DPCH timeslot format.

The receiving unit 801 is further configured to receive a radio link establishment completion response message, where the radio link establishment completion response message includes first instruction information, the first instruction information is used to instruct the base station to perform channel switching with a timing relationship kept, and the first instruction information carries an F-DPCH timing offset of the terminal in a non-Cell-DCH state, or a parameter for calculating an F-DPCH timing offset of the terminal in a non-Cell-DCH state, and/or a second F-DPCH timeslot format.

The sending unit 803 is further configured to send a reconfiguration message to the terminal, where the reconfiguration message carries the second F-DPCH timeslot format.

The receiving unit 801 is further configured to, after the sending unit 803 sends the reconfiguration message to the terminal, receive a channel switching confirmation message sent by the terminal, where the channel switching confirmation message is used to indicate that the channel of the terminal has been switched from the non-Cell-DCH to the (Cell-DCH).

A base station 90 in an embodiment of the present invention includes: an obtaining unit 901, a calculation unit 902, a receiving unit 903, a radio link establishment unit 904, and a sending unit 905.

The obtaining unit 901 is configured to, after a common enhanced dedicated channel for uplink use is allocated to a terminal, obtain a parameter for calculating an F-DPCH timing offset of the terminal in a non-Cell-DCH state.

The calculation unit 902 is configured to calculate the F-DPCH timing offset of the terminal in the non-Cell-DCH state by using the parameter for calculating the F-DPCH timing offset of the terminal in the non-Cell-DCH state that is obtained by the obtaining unit.

The receiving unit 903 is configured to receive a radio link establishment request message sent by a radio network controller, where the radio link establishment request message carries an F-DPCH configuration parameter, and the configuration parameter includes a first F-DPCH timing offset and a first F-DPCH timeslot format.

The calculation unit 902 is further configured to calculate a second F-DPCH timeslot format according to the first F-DPCH timing offset, the first F-DPCH timeslot format, and the F-DPCH timing offset of the terminal in the non-Cell-DCH state.

The radio link establishment unit 904 is configured to establish a radio link by using the F-DPCH timing offset of the terminal in the non-Cell-DCH state and the second F-DPCH timeslot format that are calculated by the calculation unit.

The sending unit 905 is configured to send a radio link establishment completion response message to the radio network controller after the radio link establishment unit establishes the radio link, where the radio link establishment completion response message includes first instruction information, the first instruction information is used to instruct the base station to perform channel switching with a timing relationship kept, and the first instruction information carries the F-DPCH timing offset of the terminal in the non-Cell-DCH state, or the parameter for calculating the F-DPCH timing offset of the terminal in the non-Cell-DCH state, and/or the second F-DPCH timeslot format.

In this embodiment of the present invention, a terminal 70 sends a data measurement report to a receiving unit 801 of a radio network controller 80, after the receiving unit 801 receives the data measurement report, a determining unit 802 determines that a channel of the terminal needs to be switched from a non-Cell-DCH to a cell dedicated channel (Cell-DCH), and a sending unit 803 sends a radio link establishment request message to a base station 90. After a common enhanced dedicated channel for uplink use is allocated to the terminal, an obtaining unit 901 of the base station obtains a parameter for calculating an F-DPCH timing offset of the terminal in a non-Cell-DCH state, and a calculation unit 902 calculates the F-DPCH timing offset of the terminal in the non-Cell-DCH state; after a receiving unit 903 receives the radio link establishment request message, after the common enhanced dedicated channel for uplink use is allocated to the terminal, the calculation unit 902 calculates a second F-DPCH timeslot format, a radio link establishment unit 904 establishes a radio link, and a sending unit 905 sends a radio link establishment completion response message to the radio network controller 80. After the receiving unit 801 receives the radio link establishment completion response message, the sending unit 803 of the radio network controller 80 sends reconfiguration message to the terminal 70, where the reconfiguration message carries the second F-DPCH timeslot format. After receiving the reconfiguration message, the terminal sends channel switching confirmation message to the radio network controller 80 to complete channel state switching.

In this embodiment of the present invention, the base station performs switching with the timing relationship kept, and at the same time, under the premise of guaranteeing that a user location in an (F-DPCH) that is specified for the terminal is unchanged, the second F-DPCH timeslot format is recalculated. Compared with channel switching without keeping a timing relationship in the prior art, this embodiment of the present invention effectively avoids occurrence of a situation where uplink data transmission of the terminal is interrupted.

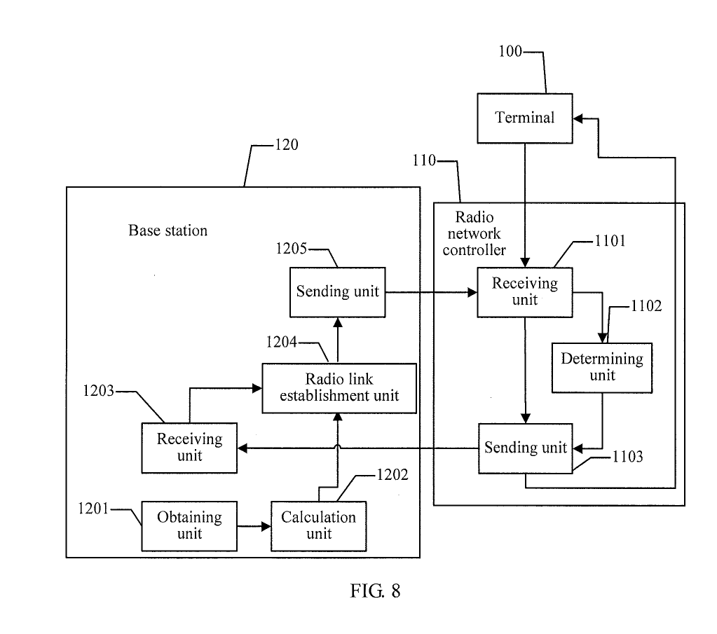

Referring to FIG. 8, a radio network controller 110 in a second embodiment of the present invention includes: a receiving unit 1101, a determining unit 1102, and a sending unit 1103.

The receiving unit 1101 is configured to, before the sending unit sends a radio link establishment request message to a base station, receive a data measurement report sent by a terminal, where the data measurement report is used to indicate a size of a data volume of the terminal.

The determining unit 1102 is configured to determine, according to the data measurement report, that a channel of the terminal needs to be switched from a non-Cell-DCH to a cell dedicated channel (Cell-DCH).

The sending unit 1103 is configured to send the radio link establishment request message to the base station, where the radio link establishment request message carries a fractional dedicated physical control channel F-DPCH configuration parameter, and the configuration parameter includes a first F-DPCH timing offset and a first F-DPCH timeslot format.

The receiving unit 1101 is configured to receive a radio link establishment completion response message, where the radio link establishment completion response message includes first instruction information, the first instruction information is used to instruct the base station to perform channel switching with a timing relationship kept, and the first instruction information carries an F-DPCH timing offset of the terminal in a non-Cell-DCH state and/or a parameter for calculating the F-DPCH timing offset of the terminal in the non-Cell-DCH state.

The sending unit 1103 is further configured to send a reconfiguration message to the terminal, where the reconfiguration message carries the first F-DPCH timeslot format.

A base station 120 in the second embodiment of the present invention includes: an obtaining unit 1201, a calculation unit 1202, a receiving unit 1203, a radio link establishment unit 1204, and a sending unit 1205.

The obtaining unit 1201 is configured to, after a common enhanced dedicated channel for uplink use is allocated to a terminal, obtain a parameter for calculating an F-DPCH timing offset of the terminal in a non-Cell-DCH state.

The calculation unit 1202 is configured to calculate the F-DPCH timing offset of the terminal in the non-Cell-DCH state by using the parameter for calculating the F-DPCH timing offset of the terminal in the non-Cell-DCH state.

The receiving unit 1203 is configured to receive a radio link establishment request message sent by a radio network controller, where the radio link establishment request message carries an F-DPCH configuration parameter, and the configuration parameter includes a first F-DPCH timing offset and a first F-DPCH timeslot format.

The radio link establishment unit 1204 is configured to, when the F-DPCH timing offset of the terminal in the non-Cell-DCH state is an integer multiple of a timeslot, establish a radio link by using the F-DPCH timing offset of the terminal in the non-Cell-DCH state that is calculated by the calculation unit and the first F-DPCH timeslot format received by the receiving unit.

The sending unit 1205 is configured to send a radio link establishment completion response message to the radio network controller after the radio link establishment unit establishes the radio link, where the radio link establishment completion response message includes first instruction information, the first instruction information is used to instruct the base station to perform channel switching with a timing relationship kept, and the first instruction information carries the F-DPCH timing offset of the terminal in the non-Cell-DCH state and/or the parameter for calculating the F-DPCH timing offset of the terminal in the non-Cell-DCH state.

In this embodiment of the present invention, a terminal 100 sends a data measurement report to a receiving unit 1101 of a radio network controller 110, after the receiving unit 1101 receives the data measurement report, a determining unit 1102 determines that a channel of the terminal needs to be switched from a non-Cell-DCH to a cell dedicated channel (Cell-DCH), and a sending unit 1103 sends a radio link establishment request message to a base station 120. After a common enhanced dedicated channel for uplink use is allocated to the terminal, an obtaining unit 1201 of the base station obtains a parameter for calculating an F-DPCH timing offset of the terminal in a non-Cell-DCH state, and a calculation unit 1202 calculates the F-DPCH timing offset of the terminal in the non-Cell-DCH state; after a receiving unit 1203 receives the radio link establishment request message, a radio link establishment unit 1204 is configured to, when the F-DPCH timing offset of the terminal in the non-Cell-DCH state is an integer multiple of a timeslot, establish a radio link by using the F-DPCH timing offset of the terminal in the non-Cell-DCH state that is calculated by the calculation unit and a first F-DPCH timeslot format that is received by the receiving unit, and a sending unit 1205 is configured to send a radio link establishment completion response message to the radio network controller after the radio link establishment unit establishes the radio link.

In this embodiment of the present invention, the base station performs switching with the timing relationship kept, when the F-DPCH timing offset of the terminal in the non-Cell-DCH state is an integer multiple of a timeslot, directly selects the first F-DPCH timeslot format as an F-DPCH configuration parameter, and performs the channel switching with timing relationship kept. Compared with channel switching without keeping a timing relationship in the prior art, this embodiment of the present invention effectively avoids occurrence of a situation where uplink data transmission of the terminal is interrupted.

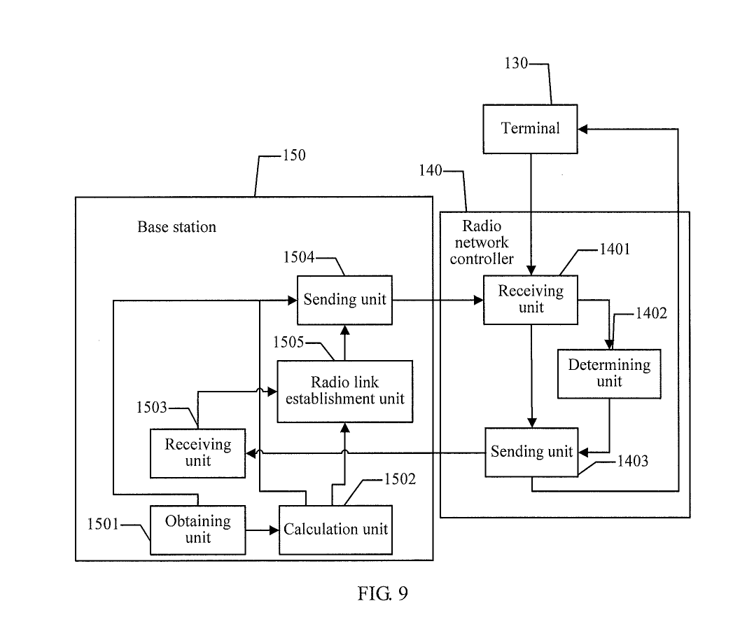

Referring to FIG. 9, a radio network controller 140 in the second embodiment of the present invention includes: a receiving unit 1401, a determining unit 1402, and a sending unit 1403.

The receiving unit 1401 is configured to, before the sending unit sends a radio link establishment request message to a base station, receive a data measurement report sent by a terminal, where the data measurement report is used to indicate a size of a data volume of the terminal.

The determining unit 1402 is configured to determine, according to the data measurement report, that a channel of the terminal needs to be switched from a non-Cell-DCH to a cell dedicated channel (Cell-DCH).

The receiving unit 1401 is configured to receive an F-DPCH timing offset of the terminal in a non-Cell-DCH state or a parameter for calculating an F-DPCH timing offset of the terminal in a non-Cell-DCH state that is sent by the base station.

The sending unit 1403 is configured to send the radio link establishment request message to the base station, where the radio link establishment request message carries a second F-DPCH timeslot format.

The receiving unit 1401 is further configured to receive a radio link establishment completion response message, where the radio link establishment completion response message includes first instruction information, and the first instruction information is used to instruct the base station to perform channel switching with a timing relationship kept.

The sending unit 1403 is further configured to send a reconfiguration message to the terminal after the receiving unit receives the radio link establishment completion response message, where the reconfiguration message carries the second F-DPCH timeslot format.

A base station 150 in an embodiment of the present invention includes: an obtaining unit 1501, a calculation unit 1502, a sending unit 1503, a receiving unit 1504, and a radio link establishment unit 1505.

The obtaining unit 1501 is configured to, after a common enhanced dedicated channel for uplink use is allocated to a terminal, obtain a parameter for calculating an F-DPCH timing offset of the terminal in a non-Cell-DCH state.

The calculation unit 1502 is configured to calculate the F-DPCH timing offset of the terminal in the non-Cell-DCH state by using the parameter for calculating the F-DPCH timing offset of the terminal in the non-Cell-DCH state that is obtained by the obtaining unit.

The sending unit 1503 is configured to send the F-DPCH timing offset of the terminal in the non-Cell-DCH state that is calculated by the calculation unit or the parameter for calculating the F-DPCH timing offset of the terminal in the non-Cell-DCH state that is obtained by the obtaining unit to a radio network controller.

The receiving unit 1504 is configured to receive a radio link establishment request message sent by the radio network controller, where the radio link establishment request message carries a second F-DPCH timeslot format.

The radio link establishment unit 1505 is configured to establish a radio link by using the F-DPCH timing offset of the terminal in the non-Cell-DCH state that is calculated by the calculation unit and the second F-DPCH timeslot format that is received by the receiving unit.

The sending unit 1503 is configured to send a radio link establishment completion response message after the radio link establishment unit establishes the radio link, where the radio link establishment completion response message includes first instruction information, and the first instruction information is used to instruct the base station to perform channel switching with a timing relationship kept.

In this embodiment of the present invention, after a common enhanced dedicated channel for uplink use is allocated to a terminal, an obtaining unit 1501 of a base station 150 obtains a parameter for calculating an F-DPCH timing offset of the terminal in a non-Cell-DCH state, a calculation unit 1502 calculates the F-DPCH timing offset of the terminal in the non-Cell-DCH state, and a sending unit 1503 sends the F-DPCH timing offset of the terminal in the non-Cell-DCH state to a receiving unit 1401 of a radio network controller 140; a sending unit 1403 of the radio network controller 140 sends a radio link establishment request message to the base station according to the F-DPCH timing offset of the terminal in the non-Cell-DCH state, where the radio link establishment request message carries a second F-DPCH timeslot format, and a radio link establishment unit 1505 establishes a radio link by using the F-DPCH timing offset of the terminal in the non-Cell-DCH state that is calculated by the calculation unit and the second F-DPCH timeslot format received by the receiving unit.

In this embodiment of the present invention, the radio network controller sends a different configuration parameter to the base station according to whether the F-DPCH timing offset of the terminal in the non-Cell-DCH state is an integer multiple of a timeslot, and when establishing the radio link, the base station selects a different F-DPCH timeslot format as a configuration parameter according to the parameter sent by the radio network controller. Compared with that channel switching kept for a timing relationship is not performed in the prior art, the embodiment of the present invention effectively avoids occurrence of a situation of interruption of uplink data transmission of the terminal.

It may be clearly understood by persons skilled in the art that, for the purpose of convenient and brief description, a detailed working process of the foregoing system, apparatus, and unit may refer to the corresponding process in the foregoing method embodiments, and the details will not be described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium, and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

It should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof, without departing from scope of the technical solutions of the embodiments of the present invention.

What is claimed is:

1. A method for parameter configuration during channel switching, comprising:
sending a radio link establishment request message to a base station, wherein the radio link establishment request message carries a fractional dedicated physical control channel F-DPCH configuration parameter, and the F-DPCH configuration parameter comprises a first F-DPCH timing offset and a first F-DPCH timeslot format; and
receiving a radio link establishment completion response message, wherein the radio link establishment completion response message comprises first instruction information, the first instruction information is used to instruct the base station to perform channel switching with a timing relationship kept, and the first instruction information carries an F-DPCH timing offset of a terminal in a non-cell dedicated channel (Cell-DCH) state, or a parameter for calculating an F-DPCH timing offset of a terminal in a non-Cell-DCH state, and/or a second F-DPCH timeslot format.

2. The method for parameter configuration during channel switching according to claim 1, after the receiving the radio link establishment completion response message, further comprising:
sending a reconfiguration message to the terminal, wherein the reconfiguration message carries the second F-DPCH timeslot format.

3. The method for parameter configuration during channel switching according to claim 2,
when the first instruction information only carries the F-DPCH timing offset of the terminal in the non-Cell-DCH state, before the sending the reconfiguration message to the terminal, further comprising:
calculating the second F-DPCH timeslot format according to the first F-DPCH timing offset, the first F-DPCH timeslot format, and the F-DPCH timing offset of the terminal in the non-Cell-DCH state; and
when the first instruction information only carries the parameter for calculating the F-DPCH timing offset of the terminal in the non-Cell-DCH state, before the step of calculating the second F-DPCH timeslot format, further comprising:
calculating the F-DPCH timing offset of the terminal in the non-Cell-DCH state by using the parameter for calculating the F-DPCH timing offset of the terminal in the non-Cell-DCH state.

4. The method for parameter configuration during channel switching according to claim 1, wherein the radio link establishment request message further carries identification information, and the identification information is used to identify whether a radio network controller allows the base station to perform the channel switching with the timing relationship kept; and
the base station can perform switching with the timing relationship kept only when the identification information identifies that the switching with the timing relationship kept is allowed to be performed.

5. A method for parameter configuration during channel switching, comprising:
obtaining a parameter for calculating an F-DPCH timing offset of a terminal in a non-Cell-DCH state after a common enhanced dedicated channel for uplink use is allocated to the terminal;
calculating the F-DPCH timing offset of the terminal in the non-Cell-DCH state by using the parameter for calculating the F-DPCH timing offset of the terminal in the non-Cell-DCH state;
receiving a radio link establishment request message sent by a radio network controller, wherein the radio link establishment request message carries an F-DPCH configuration parameter, and the F-DPCH configuration parameter comprises a first F-DPCH timing offset and a first F-DPCH timeslot format;
calculating a second F-DPCH timeslot format according to the first F-DPCH timing offset, the first F-DPCH timeslot format, and the F-DPCH timing offset of the terminal in the non-Cell-DCH state;
establishing a radio link by using the F-DPCH timing offset of the terminal in the non-Cell-DCH state and the second F-DPCH timeslot format; and
sending a radio link establishment completion response message to the radio network controller, wherein the radio link establishment completion response message comprises first instruction information, the first instruction information is used to instruct a base station to perform channel switching with a timing relationship kept, and the first instruction information carries an F-DPCH timing offset parameter of the terminal in the non-Cell-DCH state and/or the second F-DPCH timeslot format.

6. The method for parameter configuration during channel switching according to claim 5, wherein the radio link establishment request message further carries identification information, before the obtaining the parameter for calculating the F-DPCH timing offset of the terminal in the non-Cell-DCH state, further comprising:
identifying, through the identification information, whether the radio network controller allows the base station to perform the channel switching with the timing relationship kept; and
after it is identified that the identification information identifies that the base station is allowed to perform the channel switching with the timing relationship kept, obtaining the F-DPCH timing offset of the terminal in the non-Cell-DCH state.

7. A method for parameter configuration during channel switching, comprising:
sending a radio link establishment request message to a base station, wherein the radio link establishment request message carries a fractional dedicated physical control channel F-DPCH configuration parameter, and the F-DPCH configuration parameter comprises a first F-DPCH timing offset and a first F-DPCH timeslot format; and
receiving a radio link establishment completion response message, wherein the radio link establishment completion response message comprises first instruction information, the first instruction information is used to instruct the base station to perform channel switching with a timing relationship kept, and the first instruction information carries an F-DPCH timing offset of a terminal in a non-Cell-DCH state and/or a parameter for calculating the F-DPCH timing offset of the terminal in the non-Cell-DCH state.

8. The method for parameter configuration during channel switching according to claim 7, after the receiving the radio link establishment completion response message, further comprising:
sending a reconfiguration message to the terminal, wherein the reconfiguration message carries the first F-DPCH timeslot format.

9. The method for parameter configuration during channel switching according to claim 7, wherein the radio link establishment request message further carries identification information, and the identification information is used to identify whether a radio network controller allows the base station to perform the channel switching with the timing relationship kept; and
the base station can perform switching with the timing relationship kept only when the identification information identifies that the switching with the timing relationship kept is allowed to be performed.

10. A method for parameter configuration during channel switching, comprising:
obtaining a parameter for calculating an F-DPCH timing offset of a terminal in a non-Cell-DCH state after a common enhanced dedicated channel for uplink use is allocated to the terminal;
calculating the F-DPCH timing offset of the terminal in the non-Cell-DCH state by using the parameter for calculating the F-DPCH timing offset of the terminal in the non-Cell-DCH state;
receiving a radio link establishment request message sent by a radio network controller, wherein the radio link establishment request message carries an F-DPCH configuration parameter, and the F-DPCH configuration parameter comprises a first F-DPCH timing offset and a first F-DPCH timeslot format;
when the F-DPCH timing offset of the terminal in the non-Cell-DCH state is an integer multiple of a timeslot, establishing a radio link by using the F-DPCH timing offset of the terminal in the non-Cell-DCH state and the first F-DPCH timeslot format; and
sending a radio link establishment completion response message to the radio network controller, wherein the radio link establishment completion response message comprises first instruction information, the first instruction information is used to instruct a base station to perform channel switching with a timing relationship kept, and the first instruction information carries the F-DPCH timing offset of the terminal in the non-Cell-DCH state and/or the parameter for calculating the F-DPCH timing offset of the terminal in the non-Cell-DCH state.

11. The method for parameter configuration during channel switching according to claim 10, wherein the radio link establishment request message further carries identification information, before the obtaining the parameter for calculating the F-DPCH timing offset of the terminal in the non-Cell-DCH state, further comprising:
identifying, through the identification information, whether the radio network controller allows the base station to perform the channel switching with the timing relationship kept; and
after it is identified that the identification information identifies that the base station is allowed to perform the channel switching with the timing relationship kept, obtaining the F-DPCH timing offset of the terminal in the non-Cell-DCH state.

12. A method for parameter configuration during channel switching, comprising:
receiving an F-DPCH timing offset of a terminal in a non-Cell-DCH state or a parameter for calculating an F-DPCH timing offset of a terminal in a non-Cell-DCH state that is sent by a base station;
sending a radio link establishment request message to the base station, wherein the radio link establishment request message carries a second F-DPCH timeslot format; and
receiving a radio link establishment completion response message, wherein the radio link establishment completion response message comprises first instruction information, and the first instruction information is used to instruct the base station to perform channel switching with a timing relationship kept.

13. The method for parameter configuration during channel switching according to claim 12, after the receiving the radio link establishment completion response message, further comprising:
sending a reconfiguration message to the terminal, wherein the reconfiguration message carries the second F-DPCH timeslot format.

14. The method for parameter configuration during channel switching according to claim 12, wherein the radio link establishment request message further carries identification information, and the identification information is used to identify whether a radio network controller allows the base station to perform the channel switching with the timing relationship kept; and
the base station can perform switching with the timing relationship kept only when the identification information identifies that the switching with the timing relationship kept is allowed to be performed.

15. A method for parameter configuration during channel switching, comprising:
obtaining a parameter for calculating an F-DPCH timing offset of a terminal in a non-Cell-DCH state after a common enhanced dedicated channel for uplink use is allocated to the terminal;
calculating the F-DPCH timing offset of the terminal in the non-Cell-DCH state by using the parameter for calculating the F-DPCH timing offset of the terminal in the non-Cell-DCH state;
sending the F-DPCH timing offset of the terminal in the non-Cell-DCH state or the parameter for calculating the F-DPCH timing offset of the terminal in the non-Cell-DCH state to a radio network controller;
receiving a second F-DPCH timeslot format sent by the radio network controller;
establishing a radio link by using the F-DPCH timing offset of the terminal in the non-Cell-DCH state and the second F-DPCH timeslot format; and
sending a radio link establishment completion response message, wherein the radio link establishment completion response message comprises first instruction information, and the first instruction information is used to instruct a base station to perform channel switching with a timing relationship kept.

16. The method for parameter configuration during channel switching according to claim 15, wherein the radio link establishment request message further carries identification information, before the obtaining the parameter for calculating the F-DPCH timing offset of the terminal in the non-Cell-DCH state, further comprising:
identifying, through the identification information, whether the radio network controller allows the base station to perform the channel switching with the timing relationship kept; and
after it is identified that the identification information identifies that the base station is allowed to perform the channel switching with the timing relationship kept, obtaining the F-DPCH timing offset of the terminal in the non-Cell-DCH state.

17. A radio network controller, comprising:
a transmitter, configured to send a radio link establishment request message to a base station, wherein the radio link establishment request message carries a fractional dedicated physical control channel F-DPCH configuration parameter, and the F-DPCH configuration parameter comprises a first F-DPCH timing offset and a first F-DPCH timeslot format; and
a receiver, configured to receive a radio link establishment completion response message, wherein the radio link establishment completion response message comprises first instruction information, the first instruction information is used to instruct the base station to perform channel switching with a timing relationship kept, and the first instruction information carries an F-DPCH timing offset of a terminal in a non-Cell-DCH state, or a parameter for calculating an F-DPCH timing offset of a terminal in a non-Cell-DCH state, and/or a second F-DPCH timeslot format.

18. The radio network controller according to claim 17, wherein,
the transmitter is further configured to send a reconfiguration message to the terminal after the receiver receives the radio link establishment completion response message, wherein the reconfiguration message carries the second F-DPCH timeslot format.

19. The radio network controller according to claim 18, further comprising:
a processor, configured to, when the radio link establishment completion response message received by the receiver only carries the F-DPCH timing offset of the terminal in the non-Cell-DCH state or the parameter for calculating the F-DPCH timing offset of the terminal in the non-Cell-DCH state, and before the transmitter sends the reconfiguration message, calculate the second F-DPCH timeslot format according to the first F-DPCH timing offset, the first F-DPCH timeslot format, and the F-DPCH timing offset of the terminal in the non-Cell-DCH state or the parameter for calculating the F-DPCH timing offset of the terminal in the non-Cell-DCH state.

20. A base station, comprising:
a processor, configured to, after a common enhanced dedicated channel for uplink use is allocated to a terminal, obtain a parameter for calculating an F-DPCH timing offset of the terminal in a non-Cell-DCH state, and configured to calculate the F-DPCH timing offset of the terminal in the non-Cell-DCH state by using the parameter for calculating the F-DPCH timing offset of the terminal in the non-Cell-DCH state;
a receiver, configured to receive a radio link establishment request message sent by a radio network controller, wherein the radio link establishment request message carries an F-DPCH configuration parameter, the F-DPCH configuration parameter comprises a first F-DPCH timing offset and a first F-DPCH timeslot format, and
wherein the processor is further configured to calculate a second F-DPCH timeslot format according to the first F-DPCH timing offset, the first F-DPCH timeslot format, and the F-DPCH timing offset of the terminal in the non-Cell-DCH state; and configured to establish a radio link by using the F-DPCH timing offset of the terminal in the non-Cell-DCH state and the second F-DPCH timeslot format; and
a transmitter, configured to send a radio link establishment completion response message to the radio network controller after the processor establishes the radio link, wherein the radio link establishment completion response message comprises first instruction information, the first instruction information is used to instruct the base station to perform channel switching with a timing relationship kept, and the first instruction information carries the F-DPCH timing offset of the terminal in the non-Cell-DCH state, or the parameter for calculating the F-DPCH timing offset of the terminal in the non-Cell-DCH state, and/or the second F-DPCH timeslot format.

21. A radio network controller, comprising:
a transmitter, configured to send a radio link establishment request message to a base station, wherein the radio link establishment request message carries a fractional dedicated physical control channel F-DPCH configuration parameter, and the F-DPCH configuration parameter comprises a first F-DPCH timing offset and a first F-DPCH timeslot format; and
a receiver, configured to receive a radio link establishment completion response message, wherein the radio link establishment completion response message comprises first instruction information, the first instruction information is used to instruct the base station to perform channel switching with a timing relationship kept, and the first instruction information carries an F-DPCH timing offset of a terminal in a non-Cell-DCH state and/or a parameter for calculating the F-DPCH timing offset of the terminal in the non-Cell-DCH state.

22. The radio network controller according to claim 21, wherein,
the transmitter is further configured to send a reconfiguration message to the terminal after the receiver receives the radio link establishment completion response message, wherein the reconfiguration message carries the first F-DPCH timeslot format.

23. A base station, comprising:
a processor, configured to, after a common enhanced dedicated channel for uplink use is allocated to a terminal, obtain a parameter for calculating an F-DPCH timing offset of the terminal in a non-Cell-DCH state, and configured to calculate the F-DPCH timing offset of the terminal in the non-Cell-DCH state by using the parameter for calculating the F-DPCH timing offset of the terminal in the non-Cell-DCH state;
a receiver, configured to receive a radio link establishment request message sent by a radio network controller, wherein the radio link establishment request message carries an F-DPCH configuration parameter, and the F-DPCH configuration parameter comprises a first F-DPCH timing offset and a first F-DPCH timeslot format;
wherein the processor is further configured to, when the F-DPCH timing offset of the terminal in the non-Cell-DCH state is an integer multiple of a timeslot, establish a radio link by using the F-DPCH timing offset of the terminal in the non-Cell-DCH state and the first F-DPCH timeslot format received by the receiver; and
the base station further comprises a transmitter, configured to send a radio link establishment completion response message to the radio network controller after the processor establishes the radio link, wherein the radio link establishment completion response message comprises first instruction information, the first instruction information is used to instruct the base station to perform channel switching with a timing relationship kept, and the first instruction information carries the F-DPCH timing offset of the terminal in the non-Cell-DCH state and/or the parameter for calculating the F-DPCH timing offset of the terminal in the non-Cell-DCH state.

24. A radio network controller, comprising:
a receiver, configured to receive an F-DPCH timing offset of a terminal in a non-Cell-DCH state or a parameter for calculating an F-DPCH timing offset of a terminal in a non-Cell-DCH state that is sent by a base station; and
a transmitter, configured to send a radio link establishment request message to the base station, wherein the radio link establishment request message carries a second F-DPCH timeslot format, and
wherein the receiver is further configured to receive a radio link establishment completion response message, wherein the radio link establishment completion response message comprises first instruction information, and the first instruction information is used to instruct the base station to perform channel switching with a timing relationship kept.

25. The radio network controller according to claim 24, wherein,
the transmitter being further configured to send a reconfiguration message to the terminal after the receiver receives the radio link establishment completion response message, wherein the reconfiguration message carries the second F-DPCH timeslot format.

26. A base station, comprising:
a processor, configured to, after a common enhanced dedicated channel for uplink use is allocated to a terminal, obtain a parameter for calculating an F-DPCH timing offset of the terminal in a non-Cell-DCH state, and configured to calculate the F-DPCH timing offset of the terminal in the non-Cell-DCH state by using the parameter for calculating the F-DPCH timing offset of the terminal in the non-Cell-DCH state;
a transmitter, configured to send the F-DPCH timing offset of the terminal in the non-Cell-DCH state that is calculated by the processor or the parameter for calculating the F-DPCH timing offset of the terminal in the non-Cell-DCH state that is obtained by the processor to a radio network controller;
a receiver, configured to receive a radio link establishment request message sent by the radio network controller, wherein the radio link establishment request message carries a second F-DPCH timeslot format; and
wherein the processor is further configured to establish a radio link by using the F-DPCH timing offset of the terminal in the non-Cell-DCH state and the second F-DPCH timeslot format that is received by the receiver, wherein
the transmitter is further configured to send a radio link establishment completion response message after the processor establishes the radio link, wherein the radio link establishment completion response message comprises first instruction information, and the first instruction information is used to instruct the base station to perform channel switching with a timing relationship kept.
